(19) United States
(12) Patent Application Publication
(10) Pub. No.: US 2012/0176948 A1
(43) Pub. Date: Jul. 12, 2012

(54) METHOD AND SYSTEM FOR ENHANCING TRANSMISSION IN A MULTI-USER REUSING ONE SINGLE TIMESLOT OPERATION

(76) Inventors: Satish Nanjundaswamy Jamadagni, Karnataka (IN); Sarvesha Anegundi Ganapathi, Karnataka (IN); Jongsoo Choi, Wallon on Thames, Surrey (GB)

(21) Appl. No.: 13/393,049

(22) PCT Filed: Aug. 30, 2010
(86) PCT No.: PCT/KR10/05835

§ 371 Date: Feb. 28, 2012

(30) Foreign Application Priority Data
Aug. 28, 2009 (IN) 2067/CHE/2009

(51) Int. Cl. H04W 52/02

(52) U.S. Cl. 370/311

(57) ABSTRACT

A method and system for enhancing transmission in a multi-user reusing one single time slot operation. The method includes detecting a mutual interference in a traffic channel (TCH) by a network. The method also includes transmitting a discontinuous transmission (DTX) start signal by the network to a first electronic device, if the mutual interference is above a predefined value. The method further includes storing a plurality of audio and video samples by the first electronic device for a time period. Further, the method includes transmitting a DTX stop signal by the network to the first electronic device at end of the time period. Moreover, the method includes transmitting the plurality of audio and video samples by the first electronic device to a receiver using the TCH. The system includes a plurality of electronic devices, a network, and a traffic channel (TCH).

### TECHNICAL FIELD

The present disclosure relates generally to the field of wireless communication. More particularly, the present disclosure relates to a method and system for enhancing transmission in a multi-user reusing a single timeslot operation.

### BACKGROUND ART

Typically, a wireless communication system communicates data through a wireless link between a base station (BS) and an electronic device. Increasing voice traffic has led to a Multi-User Reusing One Single time slot (MUROS) operation. In the MUROS operation, multiple transmitter and receiver units are multiplexed onto one single time slot. When of the multiple transmitter and receiver units are paired in the MUROS operation, there exists adjacent channel interference (ACI) and co channel interference (CCI). The CCI refers to cross interference caused by power emitted from the multiple transmitter and receiver units using a same frequency band. The ACI is an interference caused by power emitted by a signal from a transmitter and receiver unit in an adjacent frequency band.

### DISCLOSURE OF INVENTION

### Technical Problem

Usage of the MUROS operation to increase the number of users and to handle the voice traffic increases the CCI and ACI, hence increasing overall interference. Hence, there is a need for a system and a method to address the aforementioned issues.

### Solution to Problem

Embodiments of the present disclosure described herein provide a method and system for enhancing transmission in a multi user reusing one single time slot operation.

An example of a method for enhancing transmission in a multi-user reusing one single time slot (MUROS) operation includes detecting mutual interference in a traffic channel (TCH) by a network in the MUROS operation. The method also includes, transmitting a discontinuous transmission (DTX) start signal by the network to a first electronic device, if the mutual interference is above a predefined value. The method further includes, storing a plurality of audio and video samples by the first electronic device for a time period and entering into a ‘silent period’ wherein the first electronic device does not transmit anything. The time period is provided in the DTX start signal. The time period will be calculated based on the Quality of Service (like Mean Opinion Score (MOS)) arrived at between the network and the first electronic device. Further, the method includes transmitting a DTX stop signal by the network to the first electronic device at end of the time period. Moreover, the method includes transmitting the plurality of audio and video samples by the first electronic device to a receiver using the TCH.

An example of a system for enhancing transmission in a multi-user reusing one single time slot operation includes a plurality of electronic devices configured to transmit and receive a plurality of audio and video samples in a single TCH involving a frequency band and one time slot. The system also includes a network configured to detect mutual interference in a traffic channel (TCH) in the multi-user reusing a single timeslot operation, to transmit a discontinuous transmission (DTX) start signal to a first electronic device, if the mutual interference is above a predefined value, and to transmit a DTX stop signal to the first electronic device at end of a time period. Further, the system includes the TCH configured to transmit the plurality of audio and video samples.

### ADVANTAGEOUS EFFECTS OF INVENTION

According to the present invention, it is possible to enhance transmission in a multi-user reusing a single timeslot operation.

### BRIEF DESCRIPTION OF DRAWINGS

The accompanying figure, similar reference numerals may refer to identical or functionally similar elements. These reference numerals are used in the detailed description to illustrate various embodiments and to explain various aspects and advantages of the present disclosure.

FIG. 1 illustrates a block diagram of an environment, in accordance with which various embodiments can be implemented;

FIG. 2 is a flowchart illustrating a method for enhancing transmission in a multi-user reusing one single time slot operation, in accordance with one embodiment;

FIG. 3 is an exemplary illustration of discontinuous transmission (DTX) operation, in accordance with one embodiment;

FIG. 4 is an exemplary illustration of electronic devices in discontinuous transmission (DTX) mode, in accordance with one embodiment;

FIG. 5 is a flowchart illustrating a discontinuous transmission triggering, in accordance with one embodiment; and

FIG. 6 illustrates a discontinuous transmission triggering process, in accordance with one embodiment.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various embodiments of the present disclosure.

### MODE FOR THE INVENTION

It should be observed the method steps and system components have been represented by conventional symbols in the figure, showing only specific details which are relevant for an understanding of the present disclosure. Further, details may be readily apparent to person ordinarily skilled in the art may not have been disclosed. In the present disclosure, relational terms such as first and second, and the like, may be used to distinguish one entity from another entity, without necessarily implying any actual relationship or order between such entities.

Embodiments of the present disclosure described herein provide a method and system for enhancing transmission in a multi-user reusing a single timeslot operation.

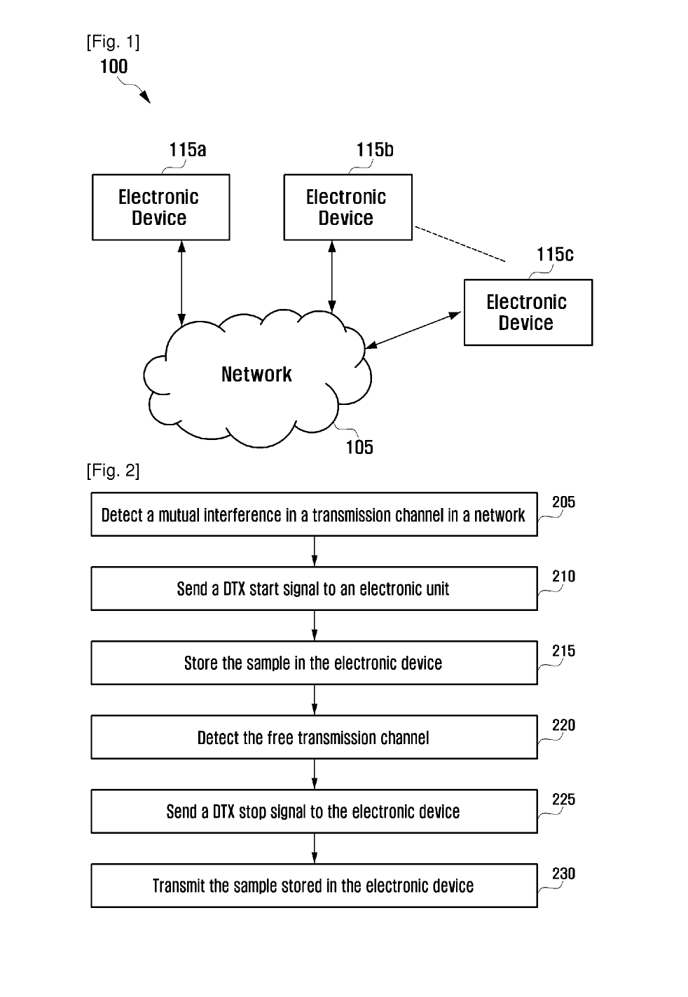

FIG. 1 illustrates a block diagram of an environment 100. The environment 100 further includes one or more electronic devices, for example an electronic device 115a, an electronic device 115b, and an electronic device 115c, which can communicate with each other through a network 105. Examples of the electronic devices include, but are not limited to, computers, mobile devices, laptops, palmtops, and personal digital assistants (PDAs). The electronic devices can also communicate with the network 105.

A user of the electronic device 115a wishes to contact a user of the electronic device 115c. The user of the electronic device 115a desires to connect to an address of the user of the electronic device 115c.

An address request and communication request sent by the user of the electronic device 115a is directly received by the network 105.

The network 105 detects a traffic control channel (TCH) for the communication between the user of the electronic device 115a and the user of the electronic device 115c.

In some embodiment the network includes a global system for mobile communications (GSM) enhanced data rates for GSM evolution radio access network (GERAN) or a universal mobile telecommunications system (UMTS) system.

The network 105 detects a mutual interference in the TCH due to a plurality of users using the TCH. The network sends a discontinuous transmission (DTX) start signal to the electronic device 115a. The electronic device 115a on receiving the DTX start signal, stores a plurality of audio and video samples from the user of the electronic device 115a. The electronic device 115a holds transmission for a time period or enters into a silent period and stores the audio and video samples.

The network 105 waits for end of the time period for the silent period for the electronic device 115a. The network 105 sends a DTX stop signal to the electronic device 115a. The electronic device 115a starts transmitting the stored audio and video samples to the network 105. The network 105 transmits the audio and video samples received by the electronic device 115a to the electronic device 115c.

In some embodiments, the DTX signal can be transmitted in an uplink mode or a downlink mode. The uplink mode is a mode of transmission from the electronic device 115a to the network 105. The downlink mode is a mode of transmission from the network 105 to the electronic device 115a.

FIG. 2 is a flowchart illustrating a method for enhancing transmission in a multi-user reusing one single time slot (MUROS) operation, in accordance with one embodiment. The method illustrates a discontinuous transmission (DTX) process applicable to uplink and downlink directions. At step 205, a network detects mutual interference in a traffic control channel (TCH). On the detection of the mutual interference in the TCH, the network initiates a DTX process. The network orders a first electronic device into a DTX mode. At step 210, the network sends a DTX start signal using the TCH or an associated control channel (ACCH) to the first electronic device. The first electronic device on detecting the DTX start signal on the ACCH or the TCH can stop transmission of a plurality of audio and video samples. At step 215, the electronic device samples and stores the audio and video samples in a buffer. The electronic device includes a built-in store and forward device to sample and store the audio and video samples. At step 220, the network detects if the TCH is idle or end of a time period is reached. The network then allocates the TCH to the first electronic device for the transmission of the audio and video samples. The first electronic device resumes transmission of the audio and video samples. At step 225, the network sends a DTX stop signal using the ACCH or TCH to the first electronic device. The first electronic device on detecting the DTX stop signal on the ACCH or TCH resumes transmission of the audio and video samples stored in the buffer. At step 230, the first electronic device transmits the stored audio and video samples using the TCH allocated by the network.

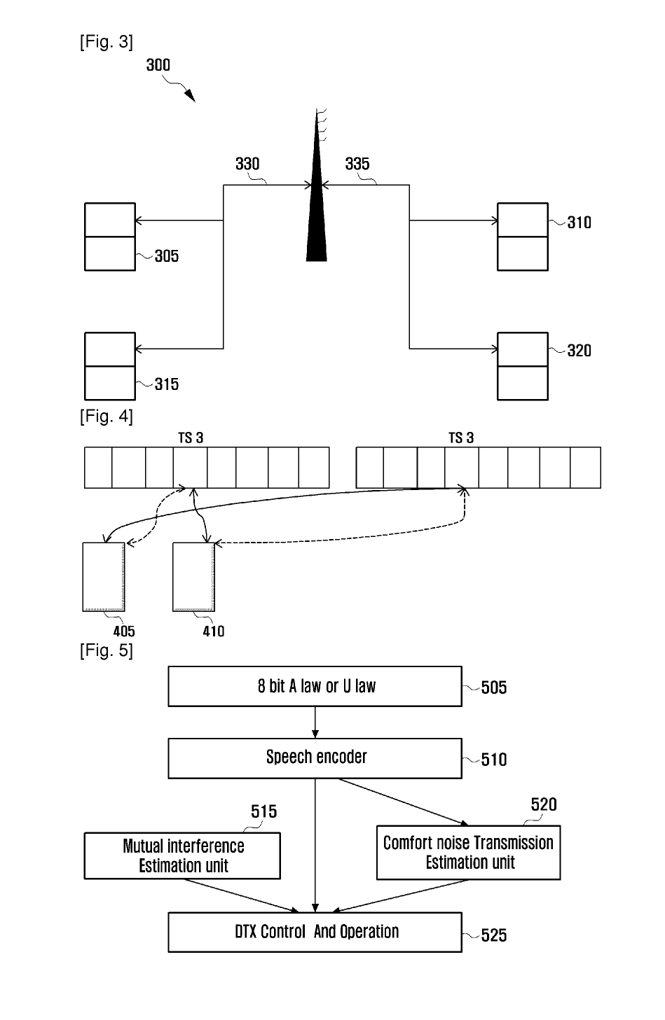

FIG. 3 an exemplary illustration of discontinuous transmission (DTX) operation, in accordance with one embodiment. A system 300 employs a discontinuous transmission (DTX) process. The network including a base station 325 transmits control signals using a bidirectional associated control channel (ACCH) or traffic control channel (TCH). The ACCH can be of two types, a slow associated control channel (SACCH) and a fast associated control channel (FACCH). The SACCH can be transmitted at predefined intervals. The system 300 includes an electronic device 305 and an electronic device 315 at a transmitter end. The electronic device 305 is transmitting a plurality of audio and video samples to a mobile user 310 located at a receiver end. Similarly, the electronic device 315 is transmitting a plurality of audio and video samples to a mobile user 320 located at the receiver end. The electronic devices 305 and 315 are using one wireless link, for example a wireless link 330 and a wireless link 335, for transmission of audio and video samples to the mobile users 310 and 320 respectively. The electronic device 305 and the electronic device 315 transmit the audio and video samples in one single time slot. The base station 325 analyzes the mutual interference between the paired electronic devices, for example the electronic device 305 and the electronic device 315. Based on the mutual interference between the paired electronic devices, the base station 325 orders the electronic device 315 into a discontinuous transmission (DTX) mode, if the mutual interference is above a predefined value. The network including the base station 325 sends a DTX start signal to the electronic device 315 using the ACCH or the TCH. The DTX start signal also includes the time period for which the electronic device 315 is in the DTX mode. The electronic device 315, on reception of the DTX start signal, stops the transmission of the audio and video samples. The electronic device 315 stores the plurality of audio and video samples. The electronic device 315 includes a built-in buffer for storing the audio and video samples. The electronic device 315 buffers the audio and video samples for a specified time period. After the specified time period, the network including the base station 325 transmits a DTX stop signal using the ACCH or the TCH. The electronic device 315, on reception of DTX stop signal resumes transmission of the audio and video samples using the wireless link 330 and the wireless link 335.

FIG. 4 is an exemplary illustration of electronic devices, for example an electronic device 405 and an electronic device 410 in a discontinuous transmission (DTX) mode.

The electronic device 405 and the electronic device 410 both use a time slot TS3 alternatively for transmission of audio and video samples.

In a first instance, the electronic device 405 is in a DTX mode for a specified time period. The electronic device 410 is assigned a traffic channel (TCH) and transmits audio and video samples using the assigned TCH. The electronic device 405 which is in the DTX mode stores a plurality of audio and video samples in a buffer for a specified time period.

In a second instance, the electronic device 410 is in the DTX mode for a specified time period. The electronic device 405 is then assigned the TCH and the electronic device 405 can transmit the audio and video samples. The electronic device 410, which is in the DTX mode, stores a plurality of audio and video samples in a buffer for the specified time period.

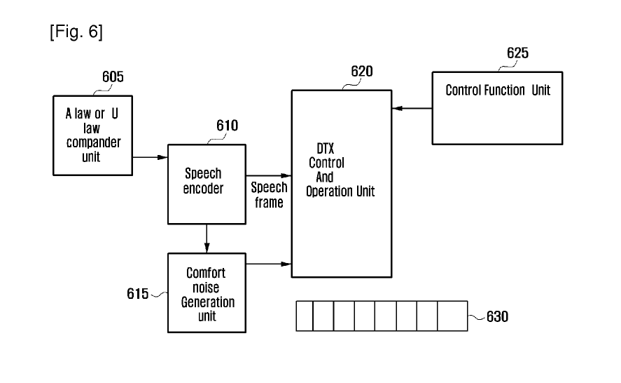

FIG. 5 is a flowchart illustrating DTX triggering, in accordance with one embodiment.

At step 505, a companding algorithm is applied to an audio signal. The companding algorithm reduces a dynamic range of the audio and video samples. An A law and U law companding algorithms used in the present embodiment requires 8 bits per sample but provides a resolution of up to 13 bits. In analog systems, the companding algorithm increases signal to noise ratio (SNR) and in digital systems the companding algorithm reduces a quantization error. At step 510, a speech signal is encoded. Speech encoding includes data compression algorithms and uses audio signal processing techniques, for example pulse code modulation (PCM) for compressing audio signals. At step 515, a network detects mutual interference present in a traffic channel (TCH). A mutual interference estimation unit detects mutual interference existing between paired electronic devices sharing one wireless link and transmitting audio and video samples at one single time slot. Based on the mutual interference, the network orders one electronic device of the paired electronic devices into a discontinuous transmission (DTX) mode. At step 520, a comfort noise is generated within an electronic device at the transmitter end. The comfort noise indicates a calling entity that a wireless connection exists between the calling entity and a called entity. At step 525, the network transmits control signals to order one electronic device of the paired electronic devices into the DTX mode. The control signals are transmitted using an associated control channel (ACCH) or the TCH.

In some embodiment the network includes a global system for mobile communications (GSM) enhanced data rates for GSM evolution radio access network (GERAN) or a universal mobile telecommunications system (UMTS) system.

FIG. 6 illustrates a block diagram for DTX triggering, in accordance with one embodiment.

The DTX triggering process includes an A law or U law compander unit 605, a speech encoder 610, a comfort noise generation unit 615, a DTX control and operation unit 620, a control function unit 625 and a buffer 630.

The A law or U law compander unit 605, is a companding algorithm used to reduce the dynamic range of the audio and video frames. The A law and U law companding algorithms used in the present embodiment requires 8 bits per sample but provides a resolution of up to 13 bits. In analog systems, the companding algorithm increases signal to noise ratio (SNR) and in digital systems the companding algorithm reduces quantization error. The speech encoder 610 includes data compression algorithms and uses specific audio signal processing techniques, for example pulse code modulation (PCM) for compressing audio signals. The comfort noise generation unit 615 generates a comfort noise. The comfort noise is generated within an electronic device. The comfort noise indicates a calling entity that a wireless connection exists between the calling entity and a called entity. The DTX control and operation unit 620 evaluates a function to control the DTX. The control function unit 625 indicates the time period until which the electronic device is in the DTX mode. The buffer 630 can be used for storing the plurality of audio and video samples. In the DTX mode, the electronic device stores the audio and video samples in the buffer 630.

In the preceding specification, the present disclosure and its advantages have been described with reference to specific embodiments. However, it will be apparent to a person of ordinary skill in the art that various modifications and changes can be made, without departing from the scope of the present disclosure, as set forth in the claims below. Accordingly, the specification and figures are to be regarded as illustrative examples of the present disclosure, rather than in restrictive sense. All such possible modifications are intended to be included within the scope of the present disclosure.

1. A method of enhancing transmission by a network in a multi-user reusing a single timeslot operation, the method comprising:
detecting mutual interference in a traffic channel (TCH) in the multi-user reusing a single timeslot (MUROS) operation;
transmitting a discontinuous transmission (DTX) start signal to a first electronic device, if the mutual interference is above a predefined value; and
transmitting a DTX stop signal to the first electronic device at end of the time period, the time period being calculated based on the Quality of Service arrived at between the network and the first electronic device.

2. The method as claimed in claim 1, further comprising:
receiving an plurality of audio and video samples from the first electronic device using the TCH.

3. The method as claimed in claim 1, wherein the transmitting DTX start signal comprises:
allowing a second electronic device to transmit a plurality of audio and video samples to the network for the time period.

4. The method as claimed in claim 1, wherein the TCH enables transmission of the plurality of audio and video samples.

5. The method as claimed in claim 1, wherein the DTX start signal is transmitted using one of the TCH and an associated control channel (ACCH).

6. The method as claimed in claim 1, wherein the DTX start signal is configured to hold transmission of the plurality of audio and video samples of the first electronic device.

7. The method as claimed in claim 1, wherein the DTX stop signal is configured to start transmission of the plurality of audio and video samples of the first electronic device.

8. The method as claimed in claim 1, wherein the DTX start signal and the DTX stop signal is transmitted in one of an uplink mode and a downlink mode.

9. A method of enhancing transmission by an electronic device in a multi-user reusing a single timeslot operation, the method comprising:
receiving a discontinuous transmission (DTX) start signal from a network;
storing a plurality of audio and video samples for a time period, wherein the time period is provided in the DTX start signal; and
entering into a silent period;

10. The method as claimed in claim 9, further comprising:
receiving a DTX stop signal from the network to at end of the time period, the time period being calculated based on the Quality of Service arrived at between the network and the electronic device; and
transmitting the plurality of audio and video samples to the network using the TCH.

11. A network of enhancing transmission in a multi-user reusing a single timeslot operation, the network comprising:
controller for detecting mutual interference in a traffic channel (TCH) in the multi-user reusing a single timeslot (MUROS) operation,
generating a discontinuous transmission (DTX) start signal to a first electronic device if the mutual interference is above a predefined value and a DTX stop signal at end of the time period calculated based on the Quality of Service arrived at between the network and the first electronic device; and
transceiver for transmitting the DTX start signal and the DTX stop signal to the first electronic device.

12. The network as claimed 11, wherein the transceiver receives an plurality of audio and video samples from the first electronic device using the TCH.

13. An electronic device of enhancing transmission in a multi-user reusing a single timeslot operation, the electronic device comprising:
transceiver for receiving a discontinuous transmission (DTX) start signal from a network; and
controller for storing a plurality of audio and video samples for a time period, wherein the time period is provided in the DTX start signal and entering into a silent period.

14. The electronic device as claimed 13, wherein the transceiver receives a DTX stop signal from the network to at end of the time period calculated based on the Quality of Service arrived at between the network and the electronic device, and transmits the plurality of audio and video samples to the network using the TCH.
